(19) United States
(12) Patent Application Publication
(10) Pub. No.: US 2015/0211726 A1
(43) Pub. Date: Jul. 30, 2015

(54) FULLY-WATERPROOF AND MAINTAINABLE LED CHRISTMAS LIGHT

(71) Applicant: YUEH-FENG WU LEE, Hsinchu City (TW)

(72) Inventor: YUEH-FENG WU LEE, Hsinchu City (TW)

(21) Appl. No.: 14/164,255

(22) Filed: Jan. 27, 2014

(51) Int. Cl. F21V 31/00; F21K 99/00

(52) U.S. Cl. CPC F21V 31/005; F21K 9/30; F21K 9/90; F21W 2121/04

(57) ABSTRACT

The invention includes an LED bulb with connection pins, soft core, soft head and electric wires with a metal sheet, wherein the LED bulb and soft core are integrated together by means of injection forming, the connection pins being exposed out of the soft core; the soft head and electric wire ends are integrated together by means of injection forming, the metal sheets being respectively exposed on two inner sides of the soft head, and the electric wires being exposed out of a bottom of the soft head; and the soft core is inserted in the soft head by means of tight fit, the connection pins being respectively attached to the metal sheets of the electric wires, thereby obtaining an LED Christmas light having a fully waterproof effect and capable of being detached for carrying out maintenance.

### TECHNICAL FIELD OF THE INVENTION

The present invention relates to a Christmas light structure on a Christmas light string, and more particularly to an LED-bulb-typed Christmas light structure.

### DESCRIPTION OF THE PRIOR ART

A current general LED Christmas light structure, as FIG. 1 shows, is mainly constituted by an LED bulb (10), soft core (20), soft head (30) and electric wires (40), where two connection pins (11) are configured on the bottom of the LED bulb, and a connection seat (21) is formed on the bottom of the soft core (20). The LED bulb (10) is inserted in the soft core (20), allowing the illumination portion of the LED bulb (10) to be exposed above the soft core (20), and the two connection pins (11) to be exposed to the outside of the connection seat (21) and then further respectively bended to attach to the left and right sides of the connection seat (21). Furthermore, an accepting groove (301) is formed inside the soft head (30), and a metal sheet (41) is fixed to one end of each electric wire (40), where the two electric wires (40) are placed in the soft head (30), allowing the metal sheets (41) of the two electric wires (40) to be respectively engaged with the left and right sides of the accepting groove (301). Thereafter, the soft core (20) coupled to the LED bulb (10) is inserted in the accepting groove (301) of the soft head (30), thereby assembling a LED Christmas light after the two connection pins (11) of the LED bulb (10) are respectively attached to the metal sheets (41) of the two electric wires (40). However, such kind of assembled LED Christmas light has many gaps in communication with one another on both the inside and outside portions thereof because the components are engaged with each other one by one such that the waterproof function of this LED is poor, causing easy damage of the LED Christmas light. It is clearly seen that such kind of LED Christmas light structure is not very ideal.

FIGS. 2 and 3 are perspective views of two improvement designs over the worse waterproof LED Christmas light mentioned above. The two connection pins (11) of the LED bulb (10) and respective exposed copper wires, as FIG. 2 shows, are soldered together in advance, and a heat-shrink film (50) is then covered firmly on the bottom of the LED bulb (10) and the ends of the electric wires (40) to cover the junction of the two connection pins (11) and two exposed copper wires (42) completely, thereby allowing the LED Christmas light to have the best waterproof function. Referring to FIG. 3 shows, the two connection pins (11) of the LED bulb (10) of the LED Christmas light and the respective exposed copper wires (42) of the two electric wires are also soldered together in advance, and the bottom of the LED bulb (10) and the ends of the electric wires (40) are further placed on a lamp shell manufacturing mold to form a Christmas light modeling shell with the soft core (20) and soft head (30) coupled to each other by means of integral injection molding, covering the junction of the two connection pins (11) and the exposed copper wires (42) completely, thereby allowing the LED Christmas light to have the best waterproof function. However, such two kinds of LED Christmas lights may have the best waterproof function, but the maintenance and replacement thereof are unable to be carried out once the LED bulb (10) is damaged. As a result, a whole LED Christmas light string is decreased in a use effect such that they are still not ideal structures.

### SUMMARY OF THE INVENTION

To improve the disadvantages of the conventional LED Christmas light structure mentioned above, the present invention is proposed.

The main object of the present invention is to provide a fully waterproof and maintainable LED Christmas light, including an LED bulb with connection pins, soft core, soft head and electric wires with a metal sheet connected to one end thereof, wherein the LED bulb and sot core are integrated together by means of injection forming, the connection pins being exposed out of the soft core; the soft head and the electric wire ends are then integrated together by means of injection forming, the metal sheets being respectively exposed on two inner sides of the soft head, and the electric wires being exposed out of a bottom of the soft head; and the soft core is inserted in the soft head by means of tight fit, the connection pins being respectively attached to the metal sheets of the electric wires, thereby allowing no gaps to be formed after the soft core is coupled to the soft head, and obtaining an LED Christmas light having a fully waterproof effect and capable of being detached for carrying out maintenance.

### BRIEF DESCRIPTION OF THE DRAWINGS

FIG. 1 is an exploded view of a conventional LED Christmas light structure assembled by components one by one;

FIG. 2 is a perspective view of another conventional LED Christmas light structure covered with a heat-shrink film;

FIG. 3 is a perspective view of still another conventional LED Christmas light structure with a single Christmas light modeling shell formed by means of integral injection forming;

FIG. 4 is a perspective view of an LED Christmas light structure formed in a series of procedures according to the present invention;

FIG. 5 is a cross-sectional view of the present invention before assembly; and

FIG. 6 is a cross-sectional view of the present invention after assembly.

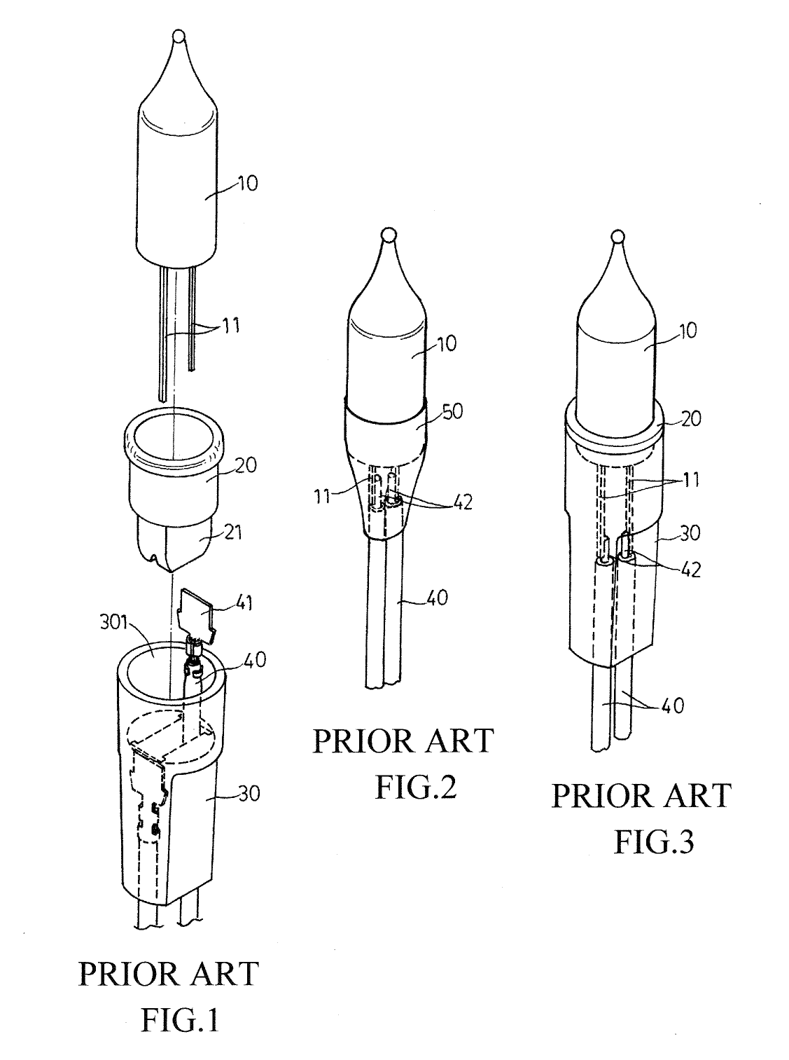

### DETAILED DESCRIPTION OF THE PREFERRED EMBODIMENTS

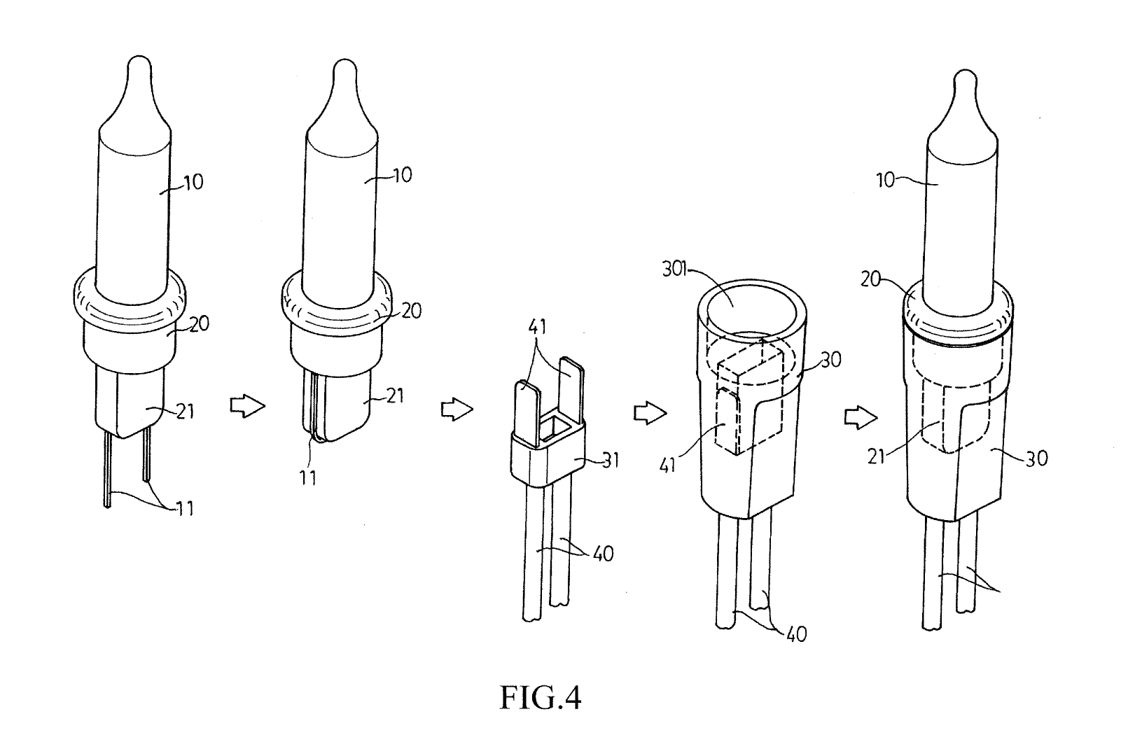

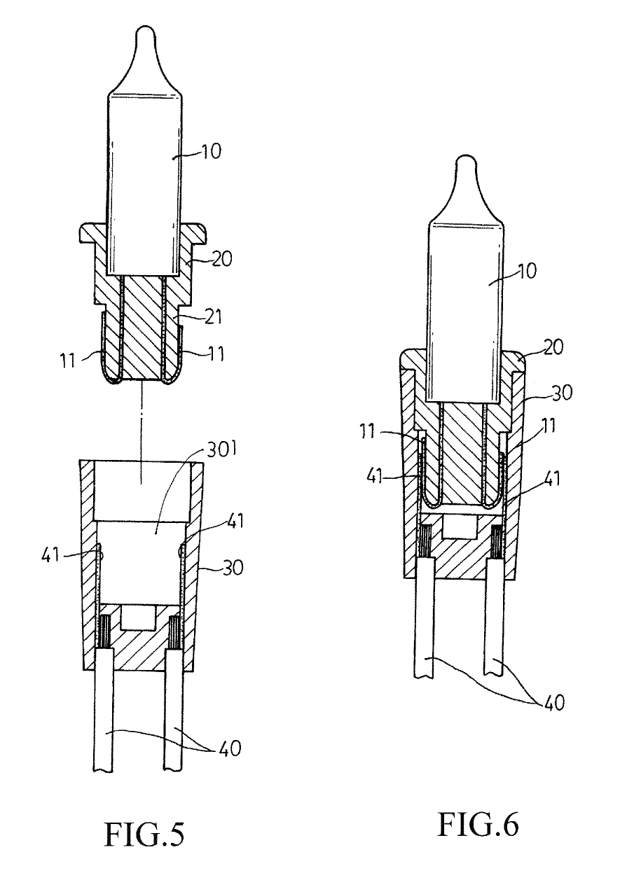

Referring to FIG. 4, which is a perspective view of a structure of the present invention during forming, a fully waterproof and maintainable LED Christmas light still mainly includes a LED bulb (10), soft core (20), soft head (30) and electric wires (40), two connection pins (11) are configured on the bottom of the LED bulb (10), a connection seat (21) on the bottom of the soft core (20), and an accepting groove (301) in the soft head (30). In addition, a metal sheet (41) is fixed to one end of each electric wire (40).

It is characterized in that the LED bulb (10) is placed on a soft core manufacturing mold, allowing the LED bulb (10) and the soft core (20) to be integrated with each other by means of injection forming, where two connection pins (21) of the LED bulb (10) are exposed out of the bottom of the connection seat (21) of the soft core (20). Thereafter, the two connection pins (21) are respectively bended and attached to the left and right sides of the connection seat (21). Next, ends of the electric wires (40) together with the respective metal sheets (41) are placed on a positioning seat manufacturing mold, forming by means of injection forming a positioning seat (31) with the metal sheet (41), the bottom of which is coupled to the top of the positioning seat (31), and the two electric wires (40), the ends of which are coupled to the bottom of the positioning seat (31), where the two metal sheets (41) are exposed out of the top of the positioning seat (31). Subsequently, the positioning seat (31) is placed on a soft head manufacturing mold, coupling the positioning seat (310 to the soft head (30) to form a unit of soft head (30) with the accepting groove (301) configured therein, where the metal sheets (41) are respectively exposed on two sides of the accepting groove (301), and the two electric wires (40) are exposed out of the bottom of the soft head (30). Finally, the soft core (20) is inserted in the soft head (30) by means of tight fit that the main body of the soft core is made slightly larger than the connection hole of the soft head (30) in diameter, and the two connection pins (11) of the LED bulb (10) are respectively attached to the metal sheets on the two sides of the accepting groove (301), allowing electric communication to be built between the LED bulb (10) and the electric wires (40), and a connection state that no gap is formed all around the soft core (20) and soft head (30), thereby achieving a fully waterproof function of the LED Christmas light and the detachable relationship between the soft core (20) and soft head (30), allowing the maintenance and replacement of the LED bulb (10) to be carried on.

I claim:

1. A fully waterproof and maintainable LED Christmas light, comprising an LED bulb with connection pins, soft core, soft head and electric wires with a metal sheet connected to one end thereof, wherein said LED bulb and sot core are integrated together by means of injection forming, said connection pins being exposed out of said soft core; said soft head and said electric wire ends are then integrated together by means of injection forming, said metal sheets being respectively exposed on two inner sides of said soft head; and said electric wires being exposed out of a bottom of said soft head, and said soft core is inserted in said soft head by means of tight fit, said connection pins being respectively attached to said metal sheets of said electric wires, thereby allowing no gaps to be formed after said soft core is coupled to said soft head, and obtaining an LED Christmas light having a fully waterproof effect and capable of being detached for carrying out maintenance.

2. The LED Christmas light according to claim 1, wherein said LED bulb is placed on a soft core manufacturing mold, allowing said LED bulb and soft core to be integrated together by means of injection forming.

3. The LED Christmas light according to claim 1, wherein said electric wire ends together with said metal sheets are placed on a positioning seat manufacturing mold first, forming a positioning seat by means of injection forming, a top of said positioning seat being coupled to bottoms of said metal sheets and a bottom thereof ends of said electric wires, and said two metal sheets being exposed out of said top of said positioning seat; and then, said positioning seat is placed on a soft head manufacturing mold, allowing said positioning seat to be coupled to an inside of said soft head to form a unit of soft head with an accepting groove configured therein by means of injection forming, said metal sheets being exposed on two sides of said accepting groove, and said electric wires being exposed out of a bottom of said soft head.

4. The LED Christmas light according to claim 1, wherein said soft core is inserted in said soft head by means of tight fit of a main body of said soft core being made slightly larger than a connection hole of said soft head in diameter, said two connection pins of said LED bulb are respectively attached to said metal sheets on two side of said accepting groove, allowing said LED bulb to be in electric communication with said electric wires, and said soft core and soft head to be in a connection state without gap all around.
